(19) United States
(12) Patent Application Publication
(10) Pub. No.: US 2010/0038194 A1
(43) Pub. Date: Feb. 18, 2010

(54) DISK BRAKE PAD HAVING REDUCED HEAT TRANSFER TO AN APPLICATION DEVICE

(76) Inventors: Robert A. Emmett, Wilberfoss (GB); Wilfried Strauss, Michelbach (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/522,478

(22) PCT Filed: Oct. 16, 2007
(86) PCT No.: PCT/EP07/08959

§ 371 Date: Jul. 8, 2009

(30) Foreign Application Priority Data
Jan. 9, 2007 (DE) 10 2007 001 378.9

(51) Int. Cl. F16D 65/847

(52) U.S. Cl. 188/264 G

(57) ABSTRACT

A disc brake lining has a carrier plate, and at least one friction lining with at least one friction surface. At least one isolation element is arranged on the side of the carrier plate opposite the friction lining.

The present invention relates to a disc brake lining of a disc brake, with a carrier plate, and at least one friction lining with at least one friction surface. More particularly, the present invention relates to a disc brake lining with reduced heat conductivity from the friction surface via the friction lining to a pressing device.

Different embodiments of disc brake linings are already known.

The EP 0503625 A discloses a brake shoe for a disc brake with a metal backing plate connected to a friction material block. A ceramic heat isolation layer holohedrally disposed by plasma spraying method is arranged between the backing plate and the friction lining. In one embodiment a square recess is provided in the backing plate, which together with a bar with approximately swallow tail shaped contour serves to attach the brake lining to a brake caliper such that a constant material thickness exists.

In U.S. Pat. No. 4,685,543 A a carrier plate for a brake lining is described, which is formed from a thin layer of corrosion-resistant material. The carrier plate has a recessed, substantially circular area corresponding to the shape of the brake piston. A thermal barrier is formed in the recessed area by an air gap between basic element and brake cylinder.

Furthermore a brake lining carrier for disc brakes, is described in the DE 1600155 A, in which an additional plate and sheet, respectively, is attached fixedly to the carrier plate of the brake lining to decrease the noise generation and to reach a lining wear as uniform as possible. The friction lining material is in direct contact with the carrier plate.

It is desirable to reduce the heat transition from the friction surface of the friction linings to the point where a pressing device engages the disc brake lining.

It is desirable to reduce the sound transmission from the friction surface to the pressing device and thus to the wheel brake.

According to an aspect of the present invention a disc brake lining of a disc brake is provided. The disc brake lining comprises a carrier plate, and at least one friction lining with at least one friction surface. The disc brake lining comprises at least one isolation element arranged on the carrier plate. The isolation element is arranged on the side of the carrier plate opposite the friction lining. Thereby, the heat transition from the carrier plate to a pressing device can be reduced substantially. Said at least one friction lining with at least one friction surface is arranged only on one side of the carrier plate.

In one embodiment the carrier plate on the side opposite the friction lining is provided with at least one elevation arranged in the area at which a pressing device abuts on the carrier plate. The elevation bulges out of the carrier plate on the side opposite the friction lining. By the elevation a gap between the carrier plate can be created which can be used for air cooling. In addition, the elevation can reduce the heat conduction from the friction lining to the pressing device, by increasing the distance between friction lining and the pressing device on the one hand, and increasing the cross section of the connection between carrier plate and the pressing device on the other hand.

In another exemplary embodiment the at least one isolation element is (respectively) arranged only in the area of the at least one elevation on the carrier plate. The material costs of the isolation element can substantially be reduced by this arrangement. In another exemplary embodiment the at least one isolation element is arranged only in the area destined for a pressing device to abut on the carrier plate there. Thereby, it is achieved that the material costs for the isolation element can be reduced further. This embodiment has the additional advantage that the part of the carrier plate not covered by the isolation element can contribute to the cooling of the brake lining.

In another exemplary embodiment the isolation element is provided with grooves. The grooves can be realized, for example, as cross grooves. Cross grooves allow that air flows through between the pressing devices and the isolation elements and thus reduces the warm transition and cools the pressing device. Cross grooves can be also used to align and center, respectively, the pressing device and the brake lining with respect to each other. It is also taken into consideration to use round recesses or, for example, star-shaped grooves.

In another exemplary embodiment the isolation element is moulded on or into the carrier plate, respectively, or sintered to the carrier plate.

According to another exemplary embodiment the isolation element is attached to the carrier plate by form-fit to the carrier plate. This can be realized, for example, by an isolation element screwed or riveted to the carrier plate. It is also possible to attach the isolation element by a snap-action mechanism to the carrier plate.

In another exemplary embodiment of the present invention the isolation element is attached to the carrier plate by force-fit. The isolation element can be attached to the carrier plate, for example, by a dowel or a pin engaging a corresponding recess in the carrier plate. It is also intended to attach the isolation element to the carrier plate by force-fit as well as by form-fit. Preferentially, the isolation element arranged between the brake piston and the carrier plate can also have moldings or protrusions, respectively, with which the isolation element can also be attached to the brake piston (for example, by form-fit and/or force-fit, for example according to the attachment of the isolation element to the carrier plate).

In another exemplary embodiment of the present invention the isolation element is a heat-isolation element. This embodiment is aimed at reducing the heating of the pressing device of the disc brake during of the brake process.

According to an additional exemplary embodiment of the present invention the isolation element is an oscillation or sound isolation element, respectively. This embodiment shall reduce the noise generation during the brake process.

In another embodiment of the present invention an isolation layer is arranged between the friction lining and the carrier plate. Thereby, the heat transition through the brake lining can be further reduced whereby it is made possible to further reduce the heating of the pressing device.

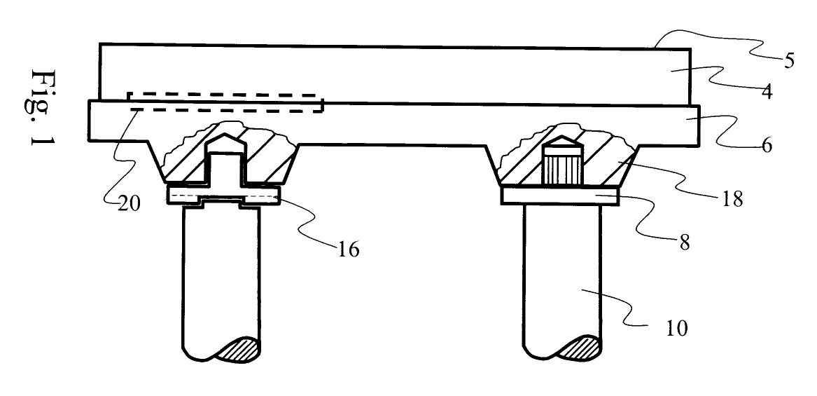

FIG. 1 shows an embodiment of a brake lining of the present invention in a partial section view.

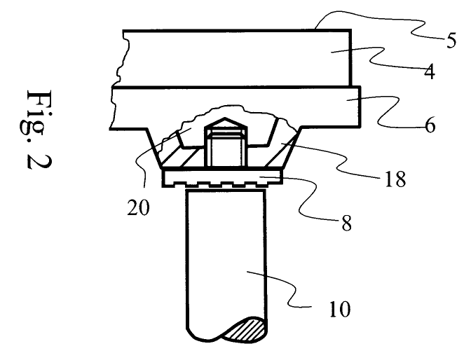

FIG. 2 shows another embodiment of a brake lining of the present invention in a partial section view.

In the following detailed description of some embodiments of the present invention the same reference numbers are used for the same or similar elements are used in the drawings as well as in the description. The figures can be partly schematic and not true-to-scale representations. It is explicitly noted here that the skilled person can, of course, combine the disclosures of the respective figures.

FIG. 1 shows an embodiment of a brake lining of the present invention in a partial section view. The illustrated disc brake lining comprises a carrier plate 6 and a friction lining 4 with a friction surface 5. In the illustrated embodiment, elevations 18 are implemented at the back of the carrier plate, which increase the distance between the friction surface and the abutment point of the pressing device 10.

The pressing devices 10 are implemented in the figures as brake pistons. For the sake of clarity, it has been omitted to illustrate further parts of the pressing device such as the brake caliper. It has also been omitted to illustrate the brake disc. Two isolation elements 8 are arranged on the side of the carrier plate 6 opposite the friction lining 4. The one isolation element 8 is implemented without any recess, wherein the contact surface to the pressing device is substantially smooth and even, respectively. The other isolation element is provided with a cross groove 16. Both isolation elements are provided with dowels serving for the attachment of the isolation elements to the carrier plate.

The isolation element 8 is attached to the carrier plate through a dowel by force-fit. The isolation element with the cross groove 16 is bonded into a corresponding recess (which must not necessarily be round) of the carrier plate through a projection or protrusion, respectively.

The brake lining can additionally be provided with an additional isolation layer 20, as indicated by the dashed rectangle, to further reduce the heat conduction from the friction surface 5 to the pressing device.

FIG. 2 shows another embodiment of a brake lining of the present invention in a partial section view.

In contrast to the brake lining illustrated in FIG. 1, the elevation 18 is implemented as a deformation of the carrier plate 6 whereby the thickness of the carrier plate is substantially identical everywhere. By this embodiment of the brake lining a recess, which in FIG. 2 is filled with an isolation layer 20, is generated on the side facing the friction lining. In FIG. 2 the isolation element 8 with an integrally molded thread is screwed into a corresponding threaded hole in the carrier plate 6. The contact surface between the isolation element 8 and the pressing device 10 has a structure further reducing the heat transition between the brake lining and the pressing device.

The present invention reduces the heat transition from brake linings to the elements of the pressing device by an isolation layer and by isolation elements, respectively, arranged at the back side of the carrier plate of the brake linings. The invention is particularly suitable for brake linings provided with elevations at the back side of the carrier plate serving as a contact surface to the pressure pistons.

The following advantages can be achieved by the present invention:
a reduction of the heat transition; and
an effective noise dampening.

At the back side of the brake lining there can be (at least one) elevation in which an isolation element is inserted by form-fit or force-fit. The isolation element can be implemented, for example, as a plate, dish or disc, respectively, with a pin projecting from it. Both form parts are produced from one material. The isolation element is produced from a material having a high pressure resistance on the one hand and a low heat transition coefficient on the other hand. In addition hereto, a noise reduction can be effected by the additional isolation element with the uncoupled transition between lining and pressure piston (i.e. pressing device). A (eigen—) frequency shift of the lining causing the noise reduction is achieved by the isolation element.

What is claimed is:

1. Disc brake lining of a disc brake, comprising:
a carrier plate
at least one friction lining with at least one friction surface, and wherein
at least one isolation element is arranged on the side of the carrier plate opposite the friction lining.

2. Disc brake lining according to claim 1, wherein the carrier plate on the side opposite the friction lining has at least one elevation arranged in the area on which a pressing device of a disc brake can abut on the carrier plate.

3. Disc brake lining according to claim 2, wherein the at least one isolation element is arranged only in the area of the at least one elevation on the carrier plate.

4. Disc brake lining according to claim 2, wherein the at least one isolation element is arranged only in the area where a pressing device abuts on the carrier plate.

5. Disc brake lining according to claim 1, wherein the isolation element is provided with grooves.

6. Disc brake lining according to claim 1, wherein the isolation element is moulded on or into the carrier plate or is sintered or bonded to the carrier plate.

7. Disc brake lining according to claim 1, wherein the isolation element is attached to the carrier plate by form-fit.

8. Disc brake lining according to claim 1, wherein the isolation element is attached to the carrier plate by force-fit.

9. Disc brake lining according to claim 1, wherein the isolation element is a heat-isolation element.

10. Disc brake lining according to claim 1, wherein the isolation element is an oscillation and sound isolation element.

11. Disc brake lining according to claim 1, wherein an isolation layer is arranged between the friction lining and the carrier plate.
